(19) United States
(12) Patent Application Publication
(10) Pub. No.: US 2006/0242007 A1
(43) Pub. Date: Oct. 26, 2006

(54) Systems and methods for advertising payments

(76) Inventors: Kian Fai Leong, Singapore (SG); Joseph Park, Redmond, WA (US); Jason Liu, Iselin, NJ (US)

Correspondence Address: Mr. Kian Fai Leong;#2190, 1263 Lakeside Dr., Sunnyvale, CA, 94085, US

(21) Appl. No.: 11/110,170

(22) Filed: Apr. 20, 2005

(51) Int. Cl. G06Q 30/00

(52) U.S. Cl. 705/14

(57) ABSTRACT

Methods and systems for generating a pay-for-performance search result by advertiser(s), who may or may not have a website or internet presence, through the Internet, wireline, and/or mobile phone network, that directly connects users to the advertiser(s) over a communication channel (e.g. cellular, wireline, VoIP phone network). Method includes receiving a search request from a user through any networked device, which generates a matching list of search results from a database server. The method by which an advertiser(s) makes a bid amount on keyword(s) or search term(s) which if selected from the search results by the user, through any networked device, will directly connect the user to the advertiser(s) by calling the associated telephone number(s) or other communication ID# or channel (e.g. VoIP address) of the advertiser(s) selected (“Pay-Per-Call”).

### CROSS REFERENCE TO RELATED APPLICATION

Not Applicable.

### STATEMENT REGARDING FEDERALLY SPONSORED RESEARCH AND DEVLOPMENT

Not Applicable.

### INCORPORATION-BY-REFERENCE OF MATERIAL SUBMITTED ON A COMPACT DISC

Not Applicable.

### BACKGROUND OF THE INVENTION

(1) Field

The disclosed methods and systems relate generally to advertising, and more particularly to pay-per-contact advertising.

(2) Description of Relevant Art

Search results provided by many search engines, in response to one or more search terms, do not rank or provide relevancy to Target(s) which do not have a physical website or internet presence. Furthermore, current pay-per-performance Internet search results are based on a user clicking on a hyperlink associated with a website associated with the search results. Advertisers that participate in this pay-per-click advertising model selects a search term(s) on which to bid that is relevant to the content of the advertiser's website. However, advertisers who do not own or operate a website or do not have an internet presence (“Non-Web Advertisers”) are unable to and/or have no reason to advertise through this pay-per-click advertising model of prior art.

Traditional Internet pay-per-performance advertising schemes are ineffective for non-web advertisers. Advertisers, including Non-Web Advertisers, should be able to directly market to Internet users who are using search engines of prior art to find a Target(s) without requiring the user to go to a Target(s) website. The Internet paid search marketplace needs to offer consumers the ability to quickly and easily find relevant search results of a Target(s) regardless of the Target(s)' web presence or lack thereof.

### SUMMARY OF THE INVENTION

Disclosed are methods and systems for generating pay-for-performance search result by advertiser(s) (“Advertiser”), who may or may not have an Internet presence, where such search results are provided through the Internet, wireline, and/or mobile phone network, that can connect users of processor-enabled devices to the advertiser(s) using one or more communications channels (e.g., cellular, wireline, VoIP phone network) (“Pay-Per-Call”). The disclosed methods and systems include receiving a search request from a user through a networked device (“device”), which generates a matching list of search results from a database server. The disclosed methods and systems allow an Advertiser to bid on individual search words, combinations of search words, and/or combinations of search word(s) and other criteria (e.g., user profile, user location, time of day, and/or situational events related to user), such that when a query is received, Advertisers having bids associated with such query can be identified. The disclosed methods and systems can generate advertisement for such identified Advertisers alongside the search results (or in another area that is distinguished from the search results), where the presentation (e.g., order, font, accessibility, etc.) of such identified Advertisers' advertisements is based on the identified Advertiser's bid amount for the respective search terms. If one or more of the identified Advertisers' advertisements is selected by the user, of a networked device, the disclosed methods and systems can connect the user to the Advertiser(s) by calling the associated telephone number(s) or other communication ID # (e.g. VoIP address). The disclosed methods and systems allow for compensation to be paid by the identified Advertisers who are so contacted, and for notification to such identified Advertisers (e.g., through introductory call message, etc.) that such contact is provided by the disclosed methods and systems (e.g., the disclosed Pay-Per-Call systems and methods).

The disclosed methods and systems contemplate methods and systems that aggregate searches and usage behaviors within a Pay-Per-Call advertising network to identify a most frequently selected and/or relevant Target(s) (i.e. a commercial business or other entity), as provided in co-pending U.S. Provisional application entitled “SYSTEMS AND METHODS FOR AGGREGATING TELEPHONY AND INTERNET DATA,” filed on the same day as the present application, and incorporated herein by reference in its entirety, although the disclosed methods and systems can be used with other search engines and are not limited to application with the aforementioned relevancy search. As users search and connect to a Target(s) through a communication channel, users' actions are captured by the system. An operator of the Pay-Per-Call advertising network (“Operator”) may use this information to more effectively target which advertisers to solicit to join its Pay-Per-Call advertising network.

The methods and systems can thus include an advertising system in which an Advertiser(s) makes a bid on keyword(s) and/or search term(s) and/or condition/criteria (e.g., user profile) to place an affiliated advertisement alongside (or otherwise distinguished from) search results otherwise generated as a result of such search. Such affiliated advertisement(s) can be presented for user selection by a networked device such that when so selected, a Pay-Per-Call process can connect the user/device to the Advertiser(s) regardless of whether an Advertiser(s) has a website. The Pay-Per-Call methods and systems can notify the Advertiser(s) that such contact/call was originated from the Pay-Per-Call advertising network (e.g., an audio clip heard by both Advertiser and device user). Such calls/contacts can be tracked and/or otherwise such occurrences recorded to allow for payment by the Advertiser(s) based on number of calls/contacts. For example, such information can be transmitted to and/or stored on a server that collects and/or aggregates such data by associating the call/contact, the user/device, the day/date/time, the Advertiser, and the Advertiser telephone/website. Such information is merely for illustration and not limitation. A fee paid by the Advertiser can be based on the number of calls/contacts provided by the Pay-Per-Call System.

The bid amounts can be generated based on an open auction process, and Advertisers can manage and bid on keywords or search terms through a medium such as an Interactive Voice Response System (“IVR”) and/or a website.

### BRIEF DESCRIPTION OF THE DRAWINGS

FIG. 1 is a flow diagram that illustrates the use of lookup tables to record the bid prices, date and time for the target being called.

FIG. 2 is a flow diagram that illustrates the price a target needs to pay based on the calls made to the target.

### DETAILED DESCRIPTION OF THE INVENTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

Unlike some pay-for-click search advertising models that require advertiser(s) to have hyperlinks attached to the search terms which direct users to advertiser(s)' websites, a Pay-Per-Call/Contact (e.g., call or contact via hyperlink) search advertising network does not require advertisers to own or operate a website as users are directly connected to advertiser(s) as server calls the associated telephone number(s) or any other communication ID# or channel (e.g. VoIP address) provided by the advertiser that is selected by the user.

In a Pay-Per-Call search advertising marketplace Targets (e.g., commercial or other entities providing products, services, information, etc.) can bid in an open auction for positions on a search result list that can be generated by a given search engine. Users that select a search result that was bid on by an Advertiser will be directly connected to the Advertiser through associated telephone number or communication ID # (e.g. VoIP address). Advertisers must pay for each connected call received from the Pay-Per-Call advertising network. Consequently, a Advertiser, including Non-Web Advertisers, can participate in this Pay-Per-Call advertising network as long as such Advertiser has a communication device to receive a phone call and/or otherwise connect to a network.

In the disclosed methods and systems, a user enters a search term that comprises one or more keywords, using a networked device, and from which a search engine generates search results of Targets. From these results, a user selects a listing or Target which enables the user to access additional information about the Target and/or to connect the user to the Target by calling the associated telephone number(s) or other communication ID #, and/or by connecting to a website. When a call is made by the device user, the disclosed methods and systems provide for client instructions that transmit the call data and/or information of the Advertiser and/or the Target being called to a server. The Target may not be an Advertiser in the Pay-Per-Call advertising network. The Target may be listed as part of a search result served to the Device user.

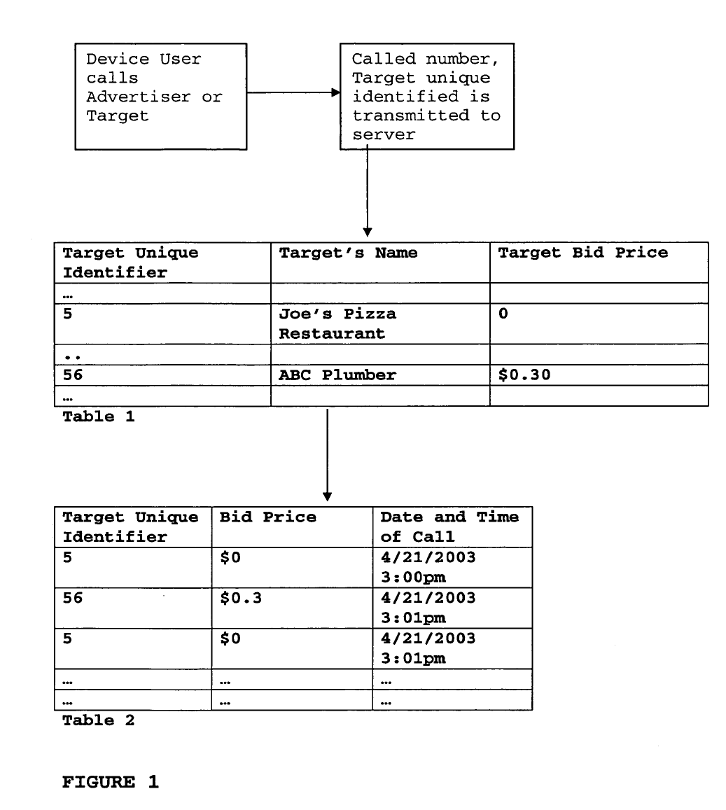

Each Target has a unique identifier index number. Along with this unique identifier, the Target's relevant information such as name, location, and/or bid price for a certain advertisement are stored in a lookup table. When a Target submits a bid for its ad placement related to a certain keyword and/or search term, the database stores the pair of (Target Unique Identifier, Bid Price) in a table such as the Table shown in FIG. 1. If a Target does not submit a bid or does not participate in the Pay-Per-Call advertising network, the Target will only be listed as part of a normal search result served to a Device user.

An Advertiser(s) can bid to place advertisements on multiple keywords and/or search terms. Furthermore, an Advertiser(s) can bid to place advertisements to target specific types of users based on user profile, location, time of day, or situational events related to the user. For example, a Pizza restaurant may bid to have its listing placed prominently on the device if a search is made for a pizza restaurant and/or the search originates from a Device that is k miles away from the Pizza restaurant. The restaurant can also bid on multiple keywords or search terms that a user may input to find a Pizza restaurant such as “Pepperoni”, “Pizza”, “Italian”, etc. Therefore, bids can be made based on multiple criteria, Cᵢ, (C₁, C₂. . . Cₙ), as well as combinations of these criteria. Criteria can include keywords, specific times of the day, and/or geographic proximity to the Advertiser. The aforementioned examples herein are not exhaustive, and are for illustration and not limitation.

In a Pay-Per-Call advertising network, Advertisers have an incentive to participate in such an open auction because the likelihood of a referral is greater when the advertisement is more prominently displayed to a user. In the disclosed methods and systems, Advertisers, including those with or without an Internet presence, can participate as long as such Advertisers have a communication device to receive a phone call or other communication.

The example FIG. 1 lookup table contains the bid amounts that each Advertiser has bid to place an advertisement with the search results served for a certain keyword or search term. In a Pay-Per-Call advertising model, the Advertiser(s) pays when a user selects the Advertiser's advertisement and the system connects the user to the Advertiser through a communication device. This payment can be consolidated and paid on a periodic basis to the Operator of the Pay-Per-Call advertising network. Since the log shown in Table 2 of FIG. 1 contains the time and date of call, a list of calls made to the Target between two different times can be summarized. The column for the bid price is then totaled to compute the payment that the Advertiser(s) owes the Operator.

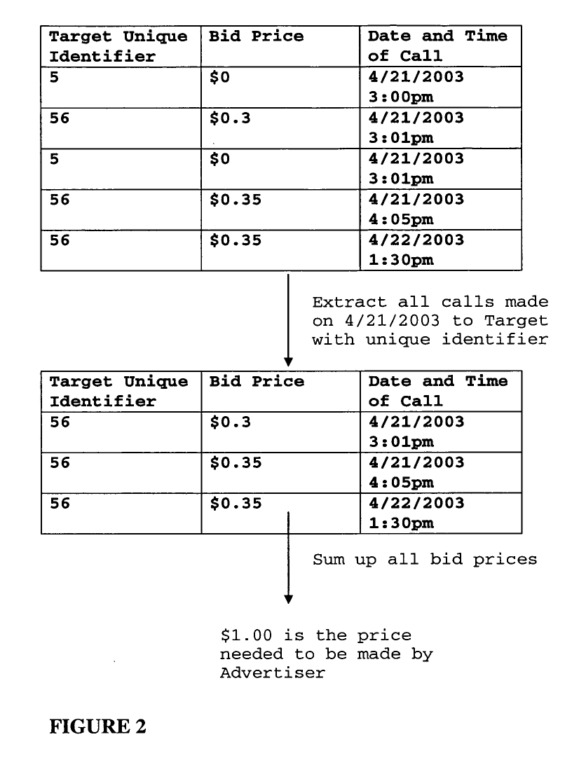

One example is shown in FIG. 2, where an Advertiser has unique identifier 56. To determine how much the Advertiser pays for calls received through the Pay-Per-Call advertising network on Apr. 21, 2003, the call log (in Table 2 of FIG. 1) is used to identify a list of calls made to the Advertiser on that date. The associated bid price of each call received is aggregated (e.g., summed) to total the final payment by the Advertiser. The bid price of each call received can be different based on different keywords and/or search terms each bid price is associated with, or different bid prices made on the same keyword and/or search term over the given time period.

An Operator can use call logs and other information (e.g. attributes of Target(s), call patterns received by Target(s), etc . . . ) that are captured by the system to determine which Target(s) to approach to enlist as an Advertiser in the Pay-Per-Call advertising network.

The number of calls made to each Target can be determined from the call log by counting the number of calls received by the Target from the system. The cumulative number of calls Cₜ for all Targets can then be computed and sorted. The results can be further segmented based on the Target's business category, location, and other attributes. The results can then be combined with other information (e.g., attributes of Target(s), call patterns received by Target(s), etc . . . ) associated with the Target(s) to derive a score Z. Within each segment, the Target(s) with the highest score Z is the most attractive potential advertiser to the Operator of the Pay-Per-Call advertising network.

In one embodiment, when a call is connected between a device user and a Target, the client software can obtain a handler to an audio portion that may reside on the device and/or a server. The audio portion can be played as the call is connected and/or prior to connection to allow the device user and Target to hear the audio portion. This audio clip/portion can notify the Target that the user being connected to the Target was delivered through the Pay-Per-Call advertising network. Once the audio clip is completely played, the audio clip/stream/portion stops and the user/caller and Target can be connected.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor” and “a processor”, or “the microprocessor” and “the processor,” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices that can be similar or different devices. Use of such “microprocessor” or “processor” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet. References herein to microprocessor instructions or microprocessor-executable instructions, in accordance with the above, can be understood to include programmable hardware.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, can be made by those skilled in the art. Accordingly, it will be understood that the disclosed methods and systems are not to be limited to the embodiments disclosed herein, can include practices otherwise than specifically described, and are to be interpreted as broadly as allowed under the law.

What is claimed is:

1. A Process and Advertising System comprising:
A Pay Per Call process that keeps track of the calls made to an advertiser on the advertising System.
A Pay Per Click process that connects a user to an advertiser regardless of whether advertiser has or has not a website.
A Process of injecting an advertising audio clip during a call transfer or connect between Device User and advertiser.
A system or process in which advertisers are allowed to bid for keywords related to a local search.
A system or Process in which Targets that belong to a search result is displayed
A Process in which Target(s) can be identified as potential advertisers based on tracking its call or click volume.

2. A computer implemented method of claim 1 in which a call from a Device over a Network will initiate the transmission of called number and the information of advertiser being called to a Server by Device.

3. A Computer implemented method of claim 1 in which the number of calls made by different Device Users determines the advertising fee paid by advertisers.

4. A Computer implemented method of claim 1 in which the price per call paid by Advertisers is determined by a market based process.

5. A Process of claim 4 in which Advertisers can bid through a medium such as a Interactive Voice Response System or a web site.

6. A Computer implemented method of claim 1 in which a client software will connect to the audio part of the Device and play an audio clip so that it can be heard by both advertiser and Caller.
